(19) United States
(12) Patent Application Publication
(10) Pub. No.: US 2014/0138255 A1
(43) Pub. Date: May 22, 2014

(54) Method for preparing a disinfectant and an electrolyzer for carrying out this method

(71) Applicants: Valeri Iltshenko, Tallinn (EE); Nikolay Nayda, Tallinn (EE)

(72) Inventors: Valeri Iltshenko, Tallinn (EE); Nikolay Nayda, Tallinn (EE)

(21) Appl. No.: 13/727,689

(22) Filed: Dec. 27, 2012

(30) Foreign Application Priority Data
Nov. 16, 2012 (EE) P201200023

(51) Int. Cl. A01N 59/00; C25B 9/08; C25B 1/22

(52) U.S. Cl. CPC A01N 59/00; C25B 1/22; C25B 9/08
USPC 205/556; 204/263

(57) ABSTRACT

The invention relates to the sphere of meeting vital requirements of people in the area of disinfection methods and equipment, involving electrolyzer and electrolysis in the sphere of chemistry. It can be used both to obtain disinfectant and to manufacture new equipment, used to obtain disinfectants.

Electrolytes are made subject to electrochemical processes of different intensity in electrode chambers of one and the same electrolyzer; relatively low in cathode chamber and relatively strong in anode chamber. In addition, the construction of electrolyzer involves elements that improve sealing properties of connection, protect materials from electrochemical influences, simplify servicing equipment, supplied with electrolyzers.

Technical results involve decreasing the fraction of electrolyte that is discharged to enhance the pH value of disinfectant obtained to 5.8-6.5 with the purpose of improving its efficiency and extend the useful lifetime of the electrolyzer and diversify its scope of application.

The method relates to the area, characterised by the demand for disinfectants that is met by electrolysing aqueous solution of sodium chloride. The method and electrolyzer applied for the implementation of the method are used to acquire disinfectants and are used in areas, characterised by high demands to hygiene and health care. Disinfectants with pH level elevated to 5.8-6.5 are the most effective, as at such pH values the active ingredient consists almost 100% of the most efficient ingredient—hypochlorouce acid.

There is a known method for obtaining disinfectant by employing a cylindrical flow-diaphragm electrolyzer, involving charging NaCl sweet-water solution into a cathode chamber where it is converted onto a catholyte; a fraction of catholyte will be directed from cathode chamber to anode chamber and some will be discharged to elevate the value of the disinfectant thus obtained. The method is described in a number of patents, involving electrolyzers; for example, patent RU 2088539 [1]0 ja and U.S. Pat. No. 5,628,888 [2], U.S. Pat. No. 5,871,623 [3], U.S. Pat. No. 5,985,110 [4], which represent further development of patent [1].

In the case of method [1], [2], [3], [4], electrolytes follow routes of the same type in both anode and cathode chamber, more specifically—along the shortest distance between the points where electrolytes enter and exit the cathode chamber.

The main disadvantage of the method described is big loss of water that is needed for catholyte discharge to achieve the disinfectant's pH value ranging between 5.8-6.5. The proportion of water loss is comparable to the pH level of 6 of the disinfectant obtained and totals to 84% of the respective volume.

Another method is known in the art, involving the use of a cylindrical diaphragm-electrolyzer, where sweet-water NaCl solution is charged into cathode chamber, some of the catholyte from cathode chamber is then directed into anode chamber and some will be discharged to elevate the pH value of the disinfectant thus obtained; during the process, electrolytes are following, in each electrode chambers, the same type of spiralling route between the input and output, along cylindrical surfaces of electrode chambers. This method is used for using electrolyzers in accordance with patents, for example, U.S. Pat. No. 7,374,645 [5], EE 05447 [6], EE 05494 [7]. The main disadvantage of the method described is big loss of water that is needed for catholyte discharge to achieve the disinfectant's pH value ranging 5.8-6.5. The proportion of water loss is comparable to the pH level of 6.0 of the disinfectant obtained and exceeds 75% of the respective volume.

There are other methods for obtaining disinfectants, using cylindrical diaphragm electrolyzers, involving a volume of catholyte discharge much smaller than in the case of methods, described above. However, these methods are either more complicated, for example, RU 2208589 [8], where the method involves consecutive passing, of electrolyte through a number of electrolyzers; RU 2241683 [9], where concentrated alkali passes through a circulation contour, consisting of cathode chamber and auxiliary container; RU 2148027 [10], RU 2157793 [11], RU 2207983 [12], involving a number of electrolyzers with circulation contours to apply the method; RU 2155719 [13], where apart a circulation contour for catholyte, a system for maintaining pressure difference between anode and cathode chamber is used EE 201000069 [14], where the optimum flow passing cathode chamber must be maintained, supported by the other flow quantity, passing anode chamber, whereas the volume flowing through anode chambers is smaller than the volume of disinfectant obtained. Additionally, a number of patents listed above, [10], [13], [8], declare obtaining disinfectants with pH level ranging 6.8-8.2; this is the range where catholyte discharge is decreased for utilisation purposes, however, the demands of consumers for disinfectants with pH rate between 5.8-6.5 may only be met under large water loss conditions.

The prior art knows electrolyzers that are intended for obtaining disinfectants. The aforementioned electrolyzers are described in patents RU 2088539 [1], U.S. Pat. No. 5,628,888 [2], U.S. Pat. No. 5,871,623 [3], U.S. Pat. No. 5,985,110 [4] and involve cylindrical flow diaphragm electrolyzers that are supplied, like the electrolyzer presented, with electrodes: anode and cathode and a diaphragm between these two components; the opposing ends of anode, cathode and diaphragm are inserted into covers that have openings in one, lower cover for entering electrolytes into cavities between the diaphragm and electrodes, i.e anode chambers whereas the other, upper cover has openings for discharging electrolyse products. The equivalent electrolyzers observed have covers that each consist of two parts. Connections between electrodes and covers and diaphragm are provided by hermetical seating ring with round cross-section, fitted between cylindrical surfaces, whereas the total construction is fixed with nuts that move along the thread on opposing ends of internal electrode. In case of the analogue devices observed, the longitudinal axes of entry and exit openings are directed radially along the longitudinal axis of the electrolyzer. These electrolyzers are widely used, however, they have certain disadvantages, for example, the demand for bigger quantity of catholyte in discharge to enhance the pH value of disinfectant, but also low performance, only totalling to 80 g of active chlorine per hour in the case of the alternatives last described.

The performance of up to 80 g active chlorine per hour is allowed in case of an electrolyzer as described in the patent U.S. Pat. No. 7,374,645 [5], being a cylindrical diaphragm electrolyzer, which has, like the electrolyzer presented, electrodes: anode and cathode—and a diaphragm fitted between the electrodes; opposing ends of anode, cathode and diaphragm are fitted into covers, consisting of 2-3 details, the lower cover having openings for letting electrolytes into electrode chamber and the upper cover having openings for discharging products of electrolysis; the cathode functions as an internal electrode and the anode—as external electrode, treated from outside with electro-hydro insulation material. In the case of the analogue device [5] observed, the connections between details are hermetically sealed with sealing rings with round cross-section. Longitudinal axes of entry and exit openings are directed along the tangent of cylindrical surfaces of electrode chambers. The main disadvantage of this electrolyzer is the requirement for large catholyte discharge volumes to enhance the pH value of disinfectant, but it also has a number of deficiencies regarding sealing aspects: upper cover consists of several parts that require sealing in connecting points; external tensioning bolts are simultaneously used to apply longitudinal pressure for sealing connecting points between details and this will raise additional requirements to manufacturing precision of details with large dimensions, including ceramic components, and will contribute to production process becoming more expensive, in general.

In the prior art there is a known electrolyzer for obtaining disinfectants with the performance up to 960 grams of active chlorine per hour, as demonstrated in patent EE 05494 [7], which uses, like the presented electrolyzer, anode as external electrode and cathode as an internal electrode; electrodes are connected by a diaphragm; opposing ends of electrodes and diaphragm are fitted into monolithic lower and upper cover; external surface of anode is treated with electro-hydro insulation material while the upper cover has an opening for discharging hydrogen from cathode chamber; the cover is fitted with a flange for the cathode and circular cylindrical ridge around the opening for the cathode; ridge is fitted with a phase turned towards the cathode at 45° angle; the anode has threads for ensuring connection with covers. The electrolyzer [7] described features connections between details, fitted with hermetically sealed round cross-section sealing rings. Longitudinal axes of entry and exit openings are directed along the tangent of cylindrical surfaces of extensions of electrode chambers. This electrolyzer [7] requires large catholyte discharge volume to adjust the pH value of disinfectant. Sealing the connection between anode and cover by compressing the rubber ring, using the phase running along the edge of the anode, results in the incurrence of stray currents on the edge of the anode and accelerated decomposition of protective layer of the ring and anode. Fixed positioning of the entry and exit openings with respect to each other restricts the allocation of the electrolyzer for building equipment of different construction.

The methods [8], [10], [11], [12], [13], [14] described above are used to solve specific functions, but are realised by applying methods and electrolyzers [1], [2], [3], [4], [6], [7] that are simple to implement and demanded by users, therefore, the prototype of the method claimed are methods described in patents RU 2088539 [1] and EE 05494 [7], while the prototype of the electrolyzer claimed is described in patent EE 05494 [7].

The purpose of the invention is to decrease water toss or, in other words, catholyte discharge that is needed for obtaining one litre of disinfectant with pH value ranging between 5.8 to 6.5.

The purpose of the invention is also to provide, in the electrolyzer, the conditions for decreasing water loss as pH value of the disinfectant is decreased to 5.8-6.5, expanding the scope of application of the electrolyzer and lengthening is useful lifetime.

The task, established for the method, is accomplished by the method used to obtain disinfectant, involving channelling electrolyte into cathode chamber of diaphragm electrolyzer, distribution of catholyte into two flows after leaving the chamber; one flow will be discharged for utilisation purposes while the other flow is channelled into anode chamber to obtain disinfectant in a volume that is equal to the volume of electrolyte, passing through the anode chamber; the following difference will be required: electrolytes in electrode chambers will be subject to electro-chemical processing of different intensity—lower intensity in cathode chamber and higher intensity in anode chamber.

The task, established for the electrolyzer, is accomplished as follows; the electrolyzer includes cylindrical electrodes, the anode being external and cathode, respectively, internal electrode; cylindrical diaphragm between the anode and the cathode, monolithic upper and lower cover with a threaded connection with the anode, flanges to ensure hermetic connection between cathode and the cover, ridges in covers for fitting the diaphragm and ensure hermetic sealing of the connection between diaphragm and the covers, which feature cylindrical extensions of cathode and anode chamber, opening in covers to allow the entry of electrolytes into extensions of cathode and anode chamber and, respectively to discharge catholyte and disinfectant (anolyte) from cathode and anode chambers; the following differences will be required: the direction of longitudinal axis for entering electrolyte into cathode chamber differs from the direction for entering electrolyte into anode chamber as follows: the longitudinal axis of entry opening to cathode chamber in lower cover runs along the radius of cylindrical extension of cathode chamber towards cathode's longitudinal axis, however, the longitudinal axis of the entry to the anode chamber in the lower cover runs along the tangent of cylindrical extensions of the anode chamber, while the longitudinal axis of anode chamber in the upper cover, which is aimed to external environment from the electrolyzer, coincides with the direction of angular velocity vector at the intersection of longitudinal axis of exit opening and cylindrical surface of anode chamber's extension.

In addition, the electrolyzer claimed differs for having longitudinal grooves along the longitudinal section of the cathode from the point in lower cover where electrolyte enters the cathode chamber up to point where it is discharged from the cathode chamber via exit opening in the upper cover.

In addition, the electrolyzer claimed differs for having another opening in the lower cover of cathode chamber's extension.

In addition, the electrolyzer claimed features another difference; connections between the anode and covers and diaphragm and the covers are sealed with rings that have rectangular cross-section and the ends of the anode feature cylindrical surfaces that have an external diameter that is smaller than external diameter of the anode while the thread is cut to match the cylindrical surfaces.

The nature of the method claim is the following: raising the pH value of anolyte in anode chamber to up to 5.8-6.5; i.e increasing the quantitative ratio of hydroxide ions and hydrogen ions in anolyte (OH⁻ and H⁺) is achieved by entering electrolyte in the form of catholyte to the anode chamber; after having subjected to electrochemical processes with relatively low intensity, catholyte will contain a small quantity of hydroxide ions, while as the consequence of electrochemical processes more intense taking place in the anode chamber, a larger quantity of hydrogen ions is formed; therefore, a relatively larger volume of catholyte will be used to enter the required quantity of hydroxide ions to the anode chamber and as the consequence, smaller volume of catholyte will be required to utilise the discharge.

Different intensity of electrochemical processes in electrode chambers of one and the same electrolyzer will be achieved by creating a difference in conditions that govern the flow of electrolyte along electrode chambers. In cathode chamber, the electrolyte will move along the shortest route between entry and exit openings in cathode chamber; while passing this short route, the main quantity of electrolyte will flow through the cathode chamber without being in contact with cathode's surface, therefore characterised by little participation in the formation of hydroxide ions.

In the anode chamber, electrolyte will flow from input to outlet along a slanting spiral following internal cylindrical surface of the anode; along the longer route the centrifugal force, created by circular movement of electrolyte, will force every micro quantity of electrolyte to the surface of electrodes, therefore, better conditions are created in anode chamber for electrochemical processes, involving separation of H⁺-ions, compared to the conditions created for the separation of OH⁻-ions in cathode chamber.

The method claimed shows decrease in losses of water, used for the utilisation of discharge, compared to methods-prototypes, for example, method [1], involving lowering of the pH value of anolyte, obtained in non-intensive hydraulic conditions, with a catholyte, which is also obtained in non-intensive hydraulic conditions, but also method [7], involving lowering of the pH value of anolyte, obtained in intensive hydraulic conditions, with a catholyte, which is also obtained in intensive hydraulic conditions. Method [1] involves the movement of electrolytes in electrode chambers along the shortest route between input and output while method [7] involves the movement of electrolytes along sloping spiralling routes in electrode chamber, following the cylindrical surfaces of cathode and anode; the method claimed features electrolyte flowing from input to output in cathode chamber along the shortest route, but in anode chamber along sloping spiralling route, following the cylindrical internal surface of the anode. At the same time, direct movement of catholyte is ensured, additionally, in cathode chamber, due to the presence of longitudinal groves along the longitudinal section of the cathode, connecting the entry point of electrolyte to the cathode chamber in the lower cover, and the cathode chamber exit point in the upper cover.

The technical results are proved by comparison of the same volumes of disinfectants, in litres, obtained with different methods, applying current of the same strength. Stabilised source of current, provided by company “Kraft Powercon”, and electrolyzer that allows to create hydraulic conditions for the movement of electrolytes for all the three methods observed, was used to ensure comparable results. Therefore, comparability of results was achieved by equivalent amount of electricity, applied from an external course, one and the same anode, diaphragm and cathode, used for all the methods to build an electrolyzer with a construction that allowed to establish hydraulic conditions for each of the methods without changing the mutual geometric location of anode, diaphragm and cathode. The curve of pH values, ranging between 5.8-6.5, was obtained by using the measuring results for cathode discharge for disinfectant obtain in several points at pH ranging from 4.8 through 7.7.

By testing the methods it was found that the discharge for the utilisation, given as a % of the volume of disinfectant obtained, for obtaining a disinfectant with pH value of 6.0, was 84.4% in the case of method [1], 75.5% for method [7] and 68.8% for the claimed method.

The invention, involved in the method, allows to obtain disinfectant with a pH value of 5.8-6.5, having an active ingredient—active chlorine—that consists, almost 100%, of the most efficient component of active chlorine for disinfecting purposes—hypo chloride acid, accompanied with smaller losses of water-based electrolyte discharged.

The technical nature of the claimed electrolyzer involves a construction that will ensure the implementation of the claimed method due to principal differences in directions of longitudinal axes of openings that allow the entry of electrolytes into electrode chambers as this will create different electrolyte flow types: in cathode chamber, the movement is mostly direct, taking the shortest route along the cathode, while in anode chamber the movement takes place along long and sloping spiral route that follows internal cylindrical surfaces of the anode. Movement along the shortest route inside the cathode chamber is facilitated by direct grooves along the length of the cathode, between the input and output of the cathode chamber.

The conditions for locating input openings has been simplified for the purpose of expanding the functional capacities of the electrolyzer. These conditions will allow the constructor to choose the mutual positioning of openings freely, depending on the construction of the equipment, featured by the electrolyzer claimed.

The positioning of cathode chamber exit openings does not have any principal importance and the opening will be located into the upper cover of the output, considering constructional specificities of the device, including the electrolyzer. Direction of longitudinal axis of anode chamber exit, that coincides with the direction of angular velocity vector of circular movement of micro quantities of anolyte at the intersection of longitudinal axis of exit opening and cylindrical surface of anode chamber's extension, facilitates maintained spiral movement along the cylindrical internal, surface of anode and thanks to minimised hydraulic resistance at the end of the spiral, upon exit from electrolyzer, also facilitates increased difference in intensity for the processing of electrolytes in electrode chambers and consequently, decreases catholyte discharge and water loss volumes. In addition, another opening in lower cover of extension of the cathode chamber allows to involve another technical servicing function—full emptying of the cathode chamber of alkaline catholyte before the electrolyzer is washed with acid to cut down the required volumes of acid. Expanded functional opportunities are not limited to elimination of alkaline catholyte, as the other opening in the lower cover of cathode chamber extensions allows to change the properties of disinfectant, in special cases, by entering additional electrolytes to electrolyzer without interfering with the main electrolyte feeding system. The positioning of the other opening does not play a material role and it will comply with the constructional specificities of the equipment, including the electrolyzer. Useful lifetime of the electrolyzer is achieved by introducing the following improvements: sealing of connections between diaphragm and covers is achieved by using rings of rectangular cross-section, as the surface of contact area of rings with rectangular cross-section and diaphragm is bigger than it would be in the case of a ring with round cross-section, contributing to better involvement of natural porous irregularities, including those present on the surface of ceramic diaphragm, and improve the quality of sealing of connections between diaphragm and covers. Connections between anode and covers are sealed with rings of rectangular cross-section, that will simultaneously allow to ensure sealing, in case of cylindrical anode surface, with simultaneously sealing of threaded end of anode, therefore improving the quality of sealing results. The sealing rings described are now fitted to external surface of the anode and outside the active zone of electric field between the anode and cathode, therefore ruling out the incurrence of stray currents inside the rings and electrochemical decomposition of rings and anodes. Cylindrical surfaces at the ends of extremities of anode are intended for the described fitting of the rings; the diameter of such surfaces is smaller than external diameter of the anode; threads for connecting the anode to covers are cut, considering the respective cylindrical surfaces.

The electrolyzer, described in the claim, will allow achieving technical results by cutting down water loss when applying the claimed method to obtain disinfectant with the pH value ranging between 5.8-6.5; the options for using and servicing the electrolyzer will be diversified and the useful lifetime of the electrolyzer extended by improving the quality of hermetic sealing of details and fitting the details into locations that are safer for the purposes of the influences of electric field.

The technical nature and operating principle of the method and electrolyzer claimed is explained with the figures described below.

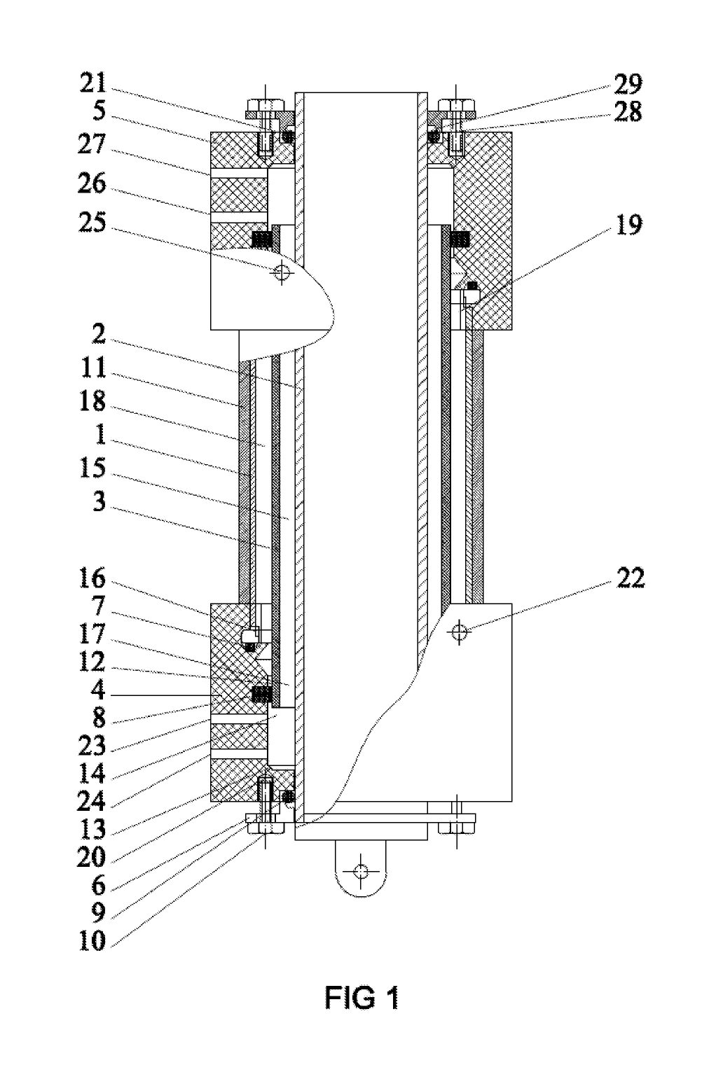

FIG. 1 depicts an electrolyzer with the following details: anode 1, cathode 2, diaphragm 3, lower cover 4, upper cover 5, flanges 6, rings with rectangular cross-section 7 to ensure hermetic connection between anode 1 and cover 4 (lower) and cover 5 (upper), rings with rectangular cross-section 8 to ensure hermetic connection between the diaphragm 3 and covers 4 and 5, rings with round cross-section to ensure hermetic connection between 9 cathode 2 and covers 4 and 5, screws 10 for moving flanges 6 along the cathode 2 towards rings 9. External surface of the anodes is treated with electro-hydro insulation material 11. Both lower cover 4 and upper cover 5 have circular edge 12 inside for fitting the diaphragm, cylindrical cavity between wall 13 and ridge 12 as an extension 14 of cathode chamber 15, cylindrical cavity between the groove 16 ridge for ring 7 and ridge 12 as an extension 17 of anode chamber 18; covers 4 and 5 have threads 19 for providing the connections with anode 1, threaded grooves 20 for fitting screws 10, groove 21 for fitting ring 9 around the opening for cathode 2. Cover 4 has an opening 22 to allow the entry of electrolyte into the extension 17 of anode chamber 18, opening 23 to allow the entry of electrolyte into the extension 14 of cathode chamber 15 and opening 24 to allow the discharge of catholyte from cathode chamber 15 for the purpose of technical servicing. Cover 5 is fitted with an opening 25 for discharging disinfectant from the extension 17 of anode chamber 18, opening 26 for discharging catholyte from the extension 14 of cathode chamber 15 and opening 27 for discharging hydrogen from extension 14. The flange 6 has a cylindrical ridge 28 for the cathode 2 around its opening. Cylindrical ridge 28 is fitted into groove 21 and will compress the phased 29 ring 9 both against the cathode 2 and the cover 4 (the same takes place with cover 5) as the flange 6 moves along the cathode 2, propelled by screws 10, thus sealing the connections between cathode 2 and the cover observed—either cover 4 or cover 5.

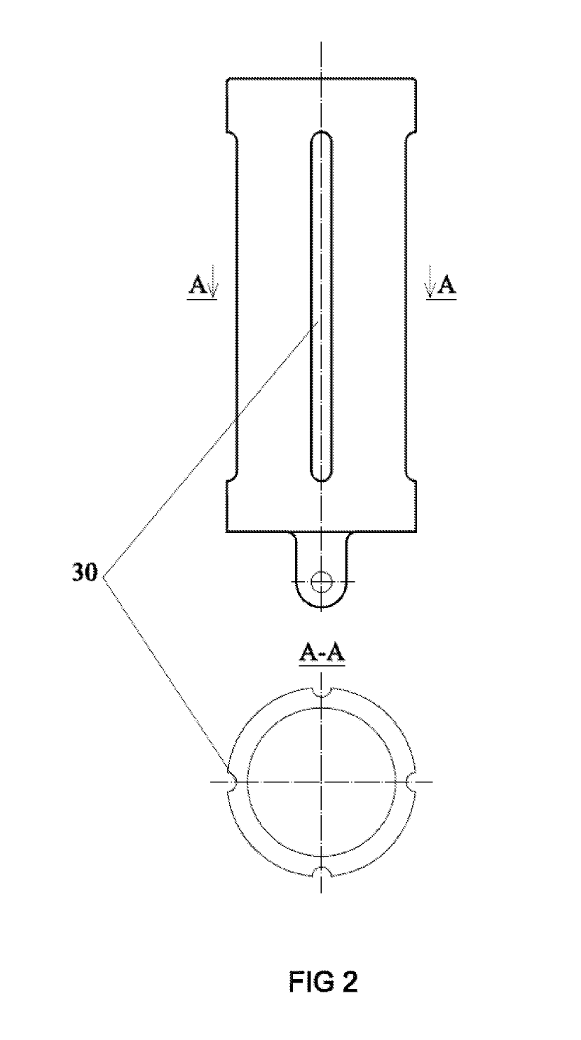

FIG. 2 depicts cathode 2, which has grooves 30 along its cylindrical external surface, running along the longitudinal axis of the cathode 2.

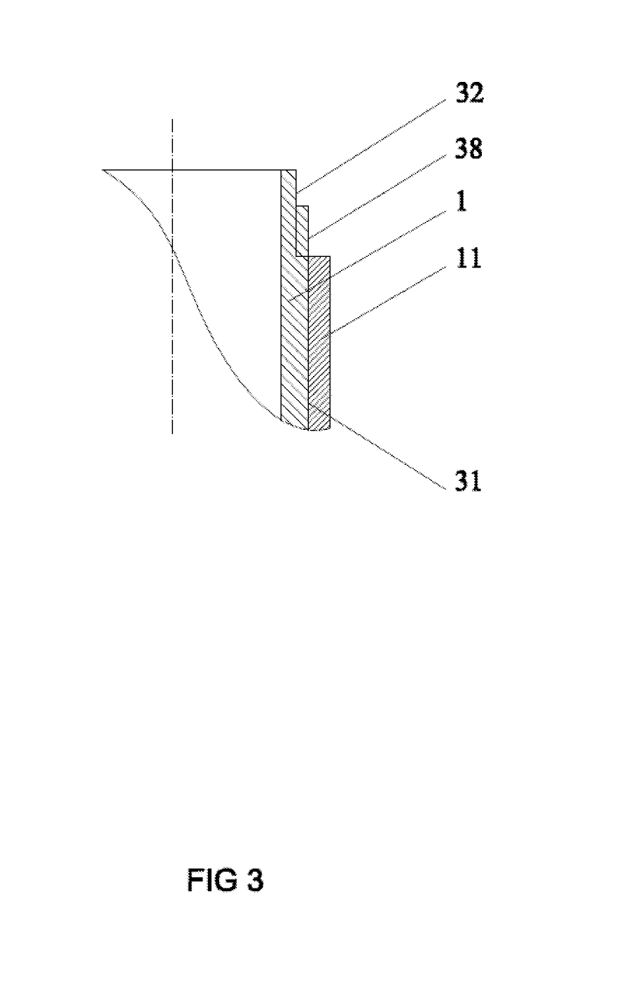

FIG. 3 depicts a fragment of one end of anode 1, which has external surface 31 with a cylindrical surface 32 of a smaller diameter, which is fitted into ring 7 as the electrolyzer is assembled, and thread 33 for connecting anode with covers 4 and 5. External surface 31 is treated, from the thread 33 at its one end to thread 33 at the other end, with electro-hydro insulation material 11.

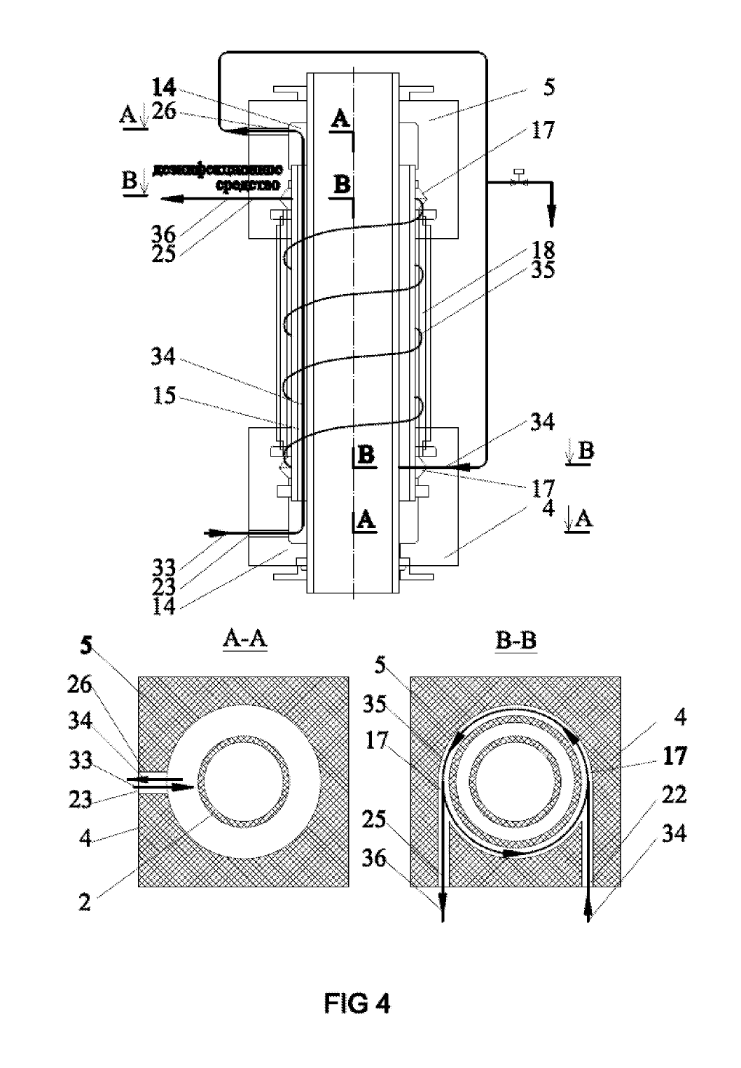

FIG. 4 depicts a schematic flow direction of electrolytes inside electrode chambers of the electrolyzer, matching the method claimed. The graduated section A-A depicts electrolyte 33 entering along opening 23 in radial direction to the extension 14 in cover 4 of the cathode chamber 15, and exiting, as catholyte 34, along the opening 26 in radial direction from the extension 14 in cover 5 of the cathode chamber 15. Graduated section B-B depicts catholyte 34 entering cylindrical extension 17 on lower cover 4 of anode chamber 18 along opening 22 in extension 17 towards the tangent of cylindrical surface, being transformed into anolyte 35 inside anode chamber 18, then proceeding to cover 5 of extension 17 of anode chamber 18, being in circular movement, and exiting as a disinfectant 36 the electrolyzer through opening 25 in extension 17 towards the direction of angular velocity vector at the intersection of longitudinal axis of exit opening 25 and cylindrical surface of anode chamber's extension 17. Frontal projection provides a schematic depiction of mostly direct movement of catholyte 34 along the shortest route inside electrolyzer from opening 23 through opening 26, movement of catholyte from opening 26 to component 37 for partial utilisation of catholyte for the discharge, movement of remaining catholyte to opening 22, spiral movement of anolyte 35 along the cylindrical surface of anode from opening 22 to opening 25 and exit, through opening 25, as a disinfectant.

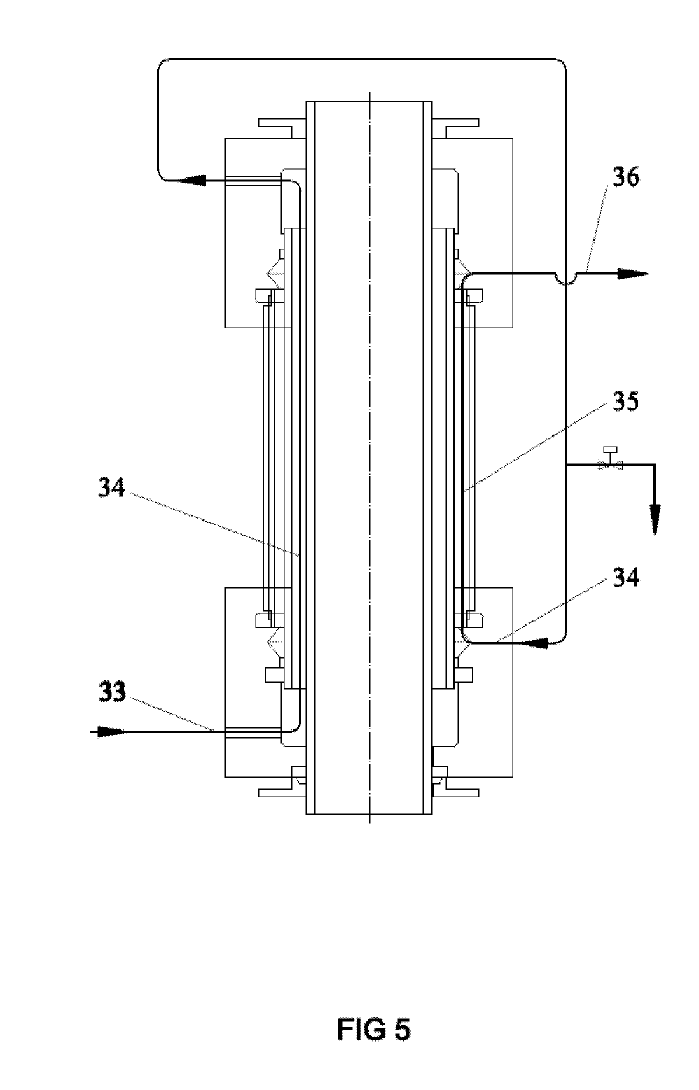

FIG. 5 provides a schematic depiction of the movement of electrolyte 33, catholyte 34, anolyte 35 and disinfectant 36 in the case of the method, described in patent RU 2088539 [1]. The nature of the movement of both catholyte 34 and anolyte 35 is of a similar type, mostly straight, along the shortest possible route from input to output opening.

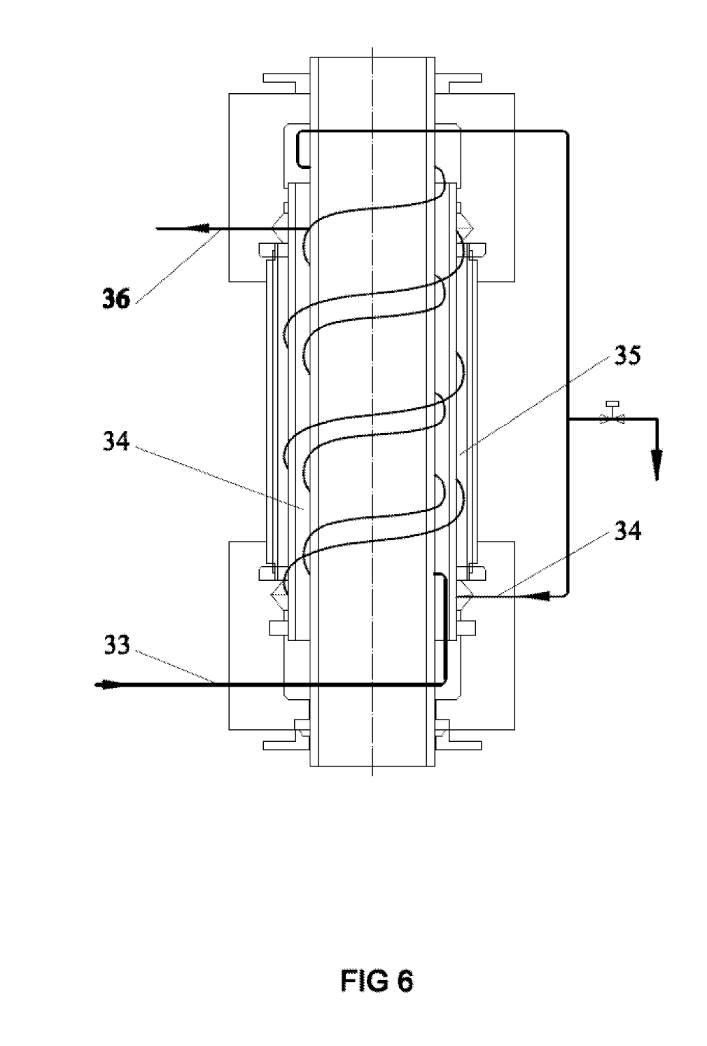

FIG. 6 provides a schematic depiction of the movement of electrolyte 33, catholyte 34, anolyte 35 and disinfectant 36 in the case of the method, described in patent EE 05494 [7]. Both catholyte 34 and anolyte 35 are characterised by a movement of the same type, towards sloping spiral, along cylindrical surfaces of electrodes.

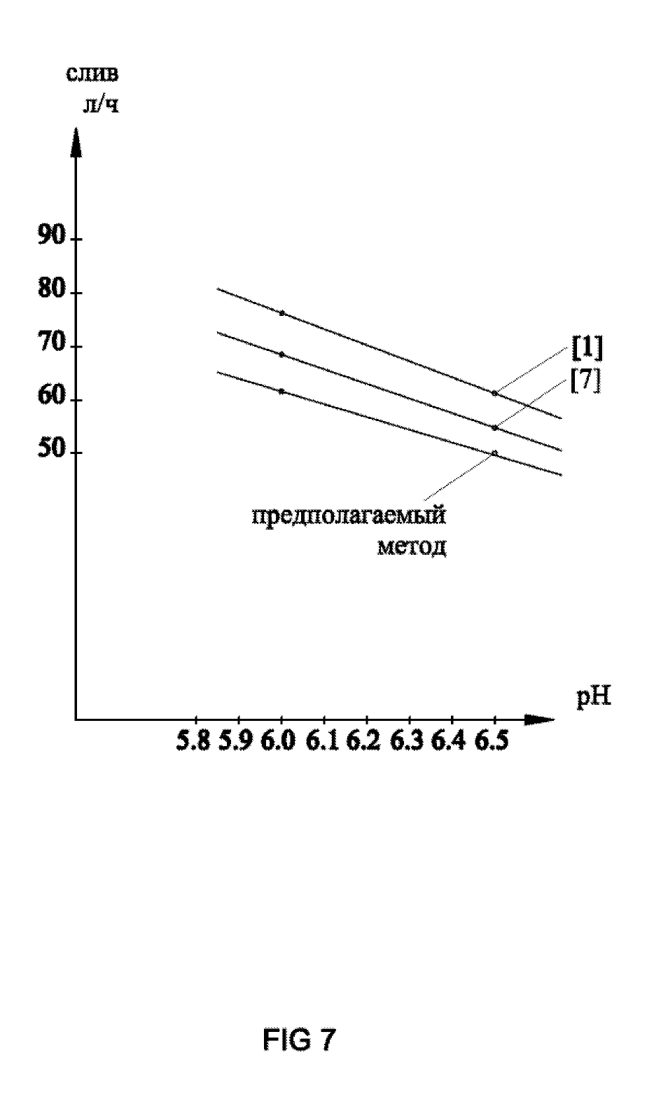

FIG. 7 depicts the results of comparative testing of methods [1], [7] and the method claim as a plot. The plot indicates at for obtaining a disinfectant with the pH value of 5.8-6.5, the requirement of electrolyte in the case of the method claim will be lower, all along the area studied, than in case of methods [1] and [7].

The alternatives for the implementation of invention claimed are demonstrated with the following example, that does not exhaust all the implementing areas of the invention.

Electrolyte flows to cathode chamber 15 extension 14 lower cover 4, moving in the direction of cathode 2, coinciding with the radius of cylindrical surface of circumference of extension 14. In cathode chamber 15, NaCl solution is transformed into catholyte, containing hydroxide ions OH⁻, between cathode and anode, by applying electric current Catholyte will then flow along the cathode chamber, mostly taking the shortest route, to exit opening 26, as this direction will determine the radial entry of electrolyte into longitudinal grooves 30 along the cathodes. From output 26, catholyte will enter device 37 for partial utilisation of catholyte discharge, and further to exit opening 22 in the extension 17 of anode chamber 18, towards the tangent of cylindrical surface of extension 17. Catholyte that contains a sufficient, of OH⁻ions and NaCl molecules, not transformed in catholyte in cathode chamber, will enter the anode chamber. In anode chamber 18 the catholyte entering will be transformed by applying electrical current and at the presence of OH⁻ions into an anolyte with a pH level of 5.8-6.5, i.e mostly containing of almost 100% hydrochloride acid, which is the most efficient ingredient of anolyte for disinfection purpose. Anolyte will flow through anode chamber 18 towards exit opening 25 along sloping spiral following cylindrical surface of anode 1, meant to flow from entry opening 22 along the tangent of cylindrical surface extension 17 of anode chamber 18 and longitudinal axis of exit opening 25 in upper cover 5 of extension 17 of anode chamber 8, which coincides with the direction of angular velocity vector of circular movement of micro quantities of anolyte at the intersection of longitudinal axis of exit opening 25 and cylindrical surface of extension 17. Anolyte with pH value 5.8-6.5 represents a disinfectant that is widely used in areas, characterised by enhanced requirements to hygiene and health care aspects.

1. A method for preparing a disinfectant from an anode chamber of a cylindrical flow diaphragm electrolyzer, in a volume, measures as litres, equal to the volume of anolyte thus obtained, involving enhancing the pH level of the disinfectant to values ranging 5.8-6.5 by channelling part of the electrolyte, i.e catholyte, into the anode chamber after passing through a cathode chamber, and using the rest of the catholyte discharge; wherein the electrolytes in the electrode chambers of the claimed electrolyzer made subject to electro-chemical processing of different intensity—lower intensity in cathode chamber and higher intensity in anode chamber.

2. An electrolyzer, comprising a cylindrical anode, a cathode and a diaphragm, lower and upper cover, both having threads to provide connection to the anode and a ridge for fitting the diaphragm and to ensure hermetic sealing between the diaphragm and the cover, the lower cover having openings for introduction of electrolytes into the electrode chambers and the upper cover having openings for discharging electrolyse products, wherein the longitudinal axis of the entry opening to the cathode chamber in the lower cover runs along the radius of cylindrical extension of the cathode chamber, and the longitudinal axis of the entry to the anode chamber in the lower cover runs along the tangent of cylindrical extension of the anode chamber, while the longitudinal axis of the anode chamber in the upper cover coincides with the direction of the angular velocity vector at the intersection of the longitudinal axis of exit opening and the cylindrical surface of anode chamber's extension; connections between the anode and the covers and the diaphragm are sealed with rings that have rectangular cross-section; the ends of the anode feature cylindrical surfaces having an external diameter that is smaller than the diameter of the external surface of the anode; the cathode chamber also has an exit opening in the lower cover.

3. The electrolyzer according to claim 2, wherein the cathode surface in contact with catholyte has straight longitudinal grooves.

4. The electrolyzer according to claim 2, wherein the electrode chamber entry openings in the lower cover and anode chamber exit opening in the upper cover are positioned independently with respect to each other, maintaining the directions of longitudinal axes, in the interests of the construction of a device, involving the electrolyzer.

5. The electrolyzer according to claim 2, wherein exit openings in both lower and upper cover of cathode chamber are positioned, considering the interests of the construction of a device, involving the electrolyzer.
